(19) United States
(12) Patent Application Publication
(10) Pub. No.: US 2026/0186262 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Weixiao Liu, Changzhou (CN)

(21) Appl. No.: 19/342,563

(22) Filed: Sep. 27, 2025

Related U.S. Application Data
(63) Continuation of application No. PCT/CN2024/144664, filed on Dec. 31, 2024.

(51) Int. Cl. G02B 13/00; G02B 9/64

(52) U.S. Cl. CPC G02B 13/0045; G02B 9/64

(57) ABSTRACT

A camera optical lens includes seven lenses sequentially from an object side to an image side: a first lens with positive refractive power, a second lens with negative refractive power, a third lens with positive refractive power, a fourth lens with negative refractive power, a fifth lens with negative refractive power, a sixth lens with positive refractive power, and a seventh lens with negative refractive power. Following relational expressions are satisfied: 0.12≤f3*d5/(R5+R6)≤0.30; 2.20≤(R11+R12)/f6≤4.00; and 4.00≤(d3+d5)/d4≤8.50. The camera optical lens has good optical performance and characteristics of large aperture, wide-angle, and ultra-thinness, and is particularly suitable for a mobile phone camera lens assembly and a WEB camera lens composed of camera elements such as CCD, CMOS with high resolution.

### TECHNICAL FIELD

The present disclosure relates to the field of optical lenses, and in particular, to a camera optical lens suitable for handheld terminal devices such as smart phones, digital cameras, and camera devices such as monitors and PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the optical sensor is continuously reduced and the requirements on the imaging quality of the system are continuously improved, a structure with seven lenses gradually appears in the lens design. There is an urgent need for a wide-angle camera lens with excellent optical performance, small size, and sufficiently corrected aberrations.

### SUMMARY

In view of the above problems, an object of the present disclosure is to provide a camera optical lens, which has good optical performance and meets design requirements of large aperture, ultra-thinness and wide-angle.

In order to solve the above technical problem, the present disclosure provides a camera optical lens including seven lenses sequentially from an object side to an image side: a first lens with positive refractive power, a second lens with negative refractive power, a third lens with positive refractive power, a fourth lens with negative refractive power, a fifth lens with negative refractive power, a sixth lens with positive refractive power, and a seventh lens with negative refractive power; in which a focal length of the third lens is f3, a focal length of the sixth lens is f6, an on-axis thickness of the second lens is d3, an on-axis distance from an image-side surface of the second lens to an object-side surface of the third lens is d4, an on-axis thickness of the third lens is d5, a central curvature radius of the object-side surface of the third lens is R5, and a central curvature radius of an image-side surface of the third lens is R6, a central curvature radius of an object-side surface of the sixth lens is R11, a central curvature radius of an image-side surface of the sixth lens is R12, and following relational expressions are satisfied:

$$0.12 \leq f 3 * d 5 / ( R 5 + R 6 ) \leq 0.3 ;$$

$$2. 20 \leq ( R 11 + R 12 ) / f 6 \leq 4. ; and$$

$$4. \leq ( d 3 + d 5 ) / d 4 \leq 8.50 .$$

As an improvement, a central curvature radius of an object-side surface of the seventh lens is R13, a central curvature radius of an image-side surface of the seventh lens is R14, and a following relational expression is satisfied:

$$2. \leq R 13 / R 14 \leq 3.5 .$$

As an improvement, an abbe number of the first lens is v1, an abbe number of the second lens is v2, and a following relational expression is satisfied:

$$36. \leq v 1 - v 2 \leq 64.00 .$$

As an improvement, a focal length of the camera optical lens is f, a focal length of the fourth lens is f4, a focal length of the fifth lens is f5, and a following relational expression is satisfied:

$$2 \leq ( f 4 - f 5 ) / f \leq 5. .$$

As an improvement, the first lens has positive refractive power, an object-side surface of the first lens is convex in a paraxial region, and an image-side surface of the first lens is concave in a paraxial region;
a focal length of the camera optical lens is f, a focal length of the first lens is f1, a central curvature radius of the object-side surface of the first lens is R1, a central curvature radius of the image-side surface of the first lens is R2, an on-axis thickness of the first lens is d1, and a total optical length from an object-side surface of the first lens to an image plane of the camera optical lens along an optic axis of the camera optical lens is TTL, and following relational expressions are satisfied:

$$1. 00 \leq f 1 / f \leq 1.13 ;$$

$$- 2.5 \; 1 \leq ( R 1 + R 2 ) / ( R 1 - R 2 ) \leq - 2 \text{.01} ; and$$

$$0.12 \leq d 1 / TTL \leq 0.14 .$$

As an improvement, the second lens has negative refractive power, an object-side surface of the second lens is convex in the paraxial region, and an image-side surface of the second lens is concave in the paraxial region;
a focal length of the camera optical lens is f, a focal length of the second lens is f2, a central curvature radius of the object-side surface of the second lens is R3, a central curvature radius of the image-side surface of the second lens is R4, a total optical length from an object-side surface of the first lens to an image plane of the camera optical lens along an optic axis of the camera optical lens is TTL, and following relational expressions are satisfied:

$$- 5.10 \leq f 2 / f \leq - 2 \text{.44} ;$$

$$4.82 \leq ( R 3 + R 4 ) / ( R 3 - R 4 ) \leq 7.65 ; and$$

$$0.03 \leq d 3 / TTL \leq 0.04 .$$

As an improvement, the third lens has positive refractive power, an object-side surface of the third lens is convex in the paraxial region, and an image-side surface of the third lens is concave in the paraxial region;
a focal length of the camera optical lens is f, a total optical length from an object-side surface of the first lens to an image plane of the camera optical lens along an optic axis of the camera optical lens is TTL, and following relational expressions are satisfied:

$$2.06 \leq f 3 / f \leq 2.64 ;$$

$$- 1.99 \leq ( R 5 + R 6 ) / ( R 5 - R 6 ) \leq - 1.34 ; and$$

$$0.05 \leq d 5 / TTL \leq 0.08 .$$

As an improvement, the fourth lens has negative refractive power, and an object-side surface of the fourth lens is concave in the paraxial region;
a focal length of the camera optical lens is f, a focal length of the fourth lens is f4, a central curvature radius of the object-side surface of the fourth lens is R7, a central curvature radius of an image-side surface of the fourth lens is R8, an on-axis thickness of the fourth lens is d7, the total optical length from an object-side surface of the first lens to an image plane of the camera optical lens along an optic axis of the camera optical lens of the camera optical lens is TTL, and following relational expressions are satisfied:

$$- 5.65 \leq f 4 / f \leq - 2 \text{.36} ;$$

$$- 2.9 \; 4 \leq ( R 7 + R 8 ) / ( R 7 - R 8 ) \leq - 0 \text{.22} ; and$$

$$0.04 \leq d 7 / TTL \leq 0.07 .$$

As an improvement, the fifth lens has negative refractive power, an object-side surface of the fifth lens is concave in the paraxial region, and the image-side surface of the fifth lens is concave in the paraxial region;
a focal length of the camera optical lens is f, a focal length of the fifth lens is f5, a central curvature radius of the object-side surface of the fifth lens is R9, a central curvature radius of the image-side surface of the fifth lens is R10, an on-axis thickness of the fifth lens is d9, a total optical length from an object-side surface of the first lens to an image plane of the camera optical lens along an optic axis of the camera optical lens of the camera optical lens is TTL, and following relational expressions are satisfied:

$$- 9.06 \leq f 5 / f \leq - 4.36 ;$$

$$- 1.72 \leq ( R 9 + R 10 ) / ( R 9 - R 10 ) \leq 0.96 ; and$$

$$0.05 \leq d 9 / TTL \leq 0.08 .$$

As an improvement, the sixth lens has positive refractive power, an object-side surface of the sixth lens is convex in the paraxial region, and an image-side surface of the sixth lens is concave in the paraxial region;
a focal length of the camera optical lens is f, a focal length of the sixth lens is f6, an on-axis thickness of the fifth lens is d11, a total optical length from an object-side surface of the first lens to an image plane of the camera optical lens along an optic axis of the camera optical lens of the camera optical lens is TTL, and following relational expressions are satisfied:

$$1. 35 \leq f 6 / f \leq 1.53 ;$$

$$- 1.66 \leq ( R 11 + R 12 ) / ( R 11 - R 12 ) \leq - 1.33 ;$$

$$0.07 \leq d 11 / TTL \leq 0.11 .$$

As an improvement, the seventh lens has negative refractive power, an object-side surface of the seventh lens is convex in the paraxial region, and an image-side surface of the seventh lens is concave in the paraxial region;
a focal length of the camera optical lens is f, a focal length of the seventh lens is f7, a central curvature radius of the object-side surface of the seventh lens is R13, a central curvature radius of the image-side surface of the seventh lens is R14, an on-axis thickness of the seventh lens is d13, a total optical length from an object-side surface of the first lens to an image plane of the camera optical lens along an optic axis of the camera optical lens of the camera optical lens is TTL, and following relational expressions are satisfied:

$$- 1.64 \leq f 7 / f \leq - 0 \text{.84} ;$$

$$1. 80 \leq ( R 13 + R 14 ) / ( R 13 - R 14 ) \leq 3. ;$$

$$0.05 \leq d 13 / TTL \leq 0.13 .$$

As an improvement, the first lens is made of glass.

The present disclosure has following beneficial effects: the camera optical lens as described in the present disclosure has good optical performance and characteristics of large aperture, wide-angle, and ultra-thinness, and is particularly suitable for a mobile phone camera lens assembly and a WEB camera lens composed of camera elements such as CCD, CMOS with high resolution.

### BRIEF DESCRIPTION OF DRAWINGS

In order to more clearly illustrate technical solutions of embodiments of the present disclosure, the drawings to be used in the embodiments will be briefly described below. The drawings in the following description are some embodiments of the present disclosure. For those skilled in the art, other drawings may also be obtained based on these drawings.

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13; and

FIG. 16 is a schematic diagram of field curvature and distortion of the camera optical lens shown in FIG. 13.

### DESCRIPTION OF EMBODIMENTS

In order to more clearly illustrate objectives, technical solutions, and advantages of embodiments of the present disclosure, the following will provide a detailed description of various embodiments of the present disclosure in combination with the drawings. However, it should be understood by those skilled in the art that in each embodiment of the present disclosure, many technical details are presented to help readers better understand the present disclosure. However, even without these technical details and various changes and modifications based on the following embodiments, the technical solutions required to be protected by the present disclosure can still be achieved.

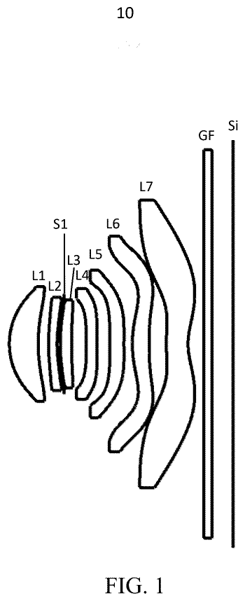

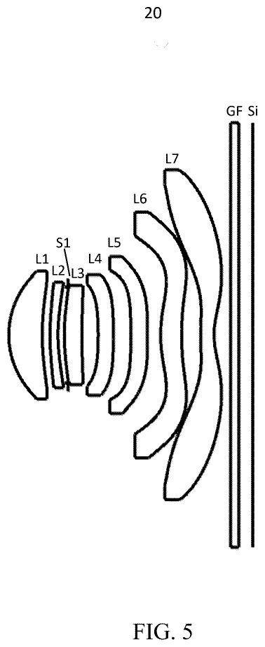

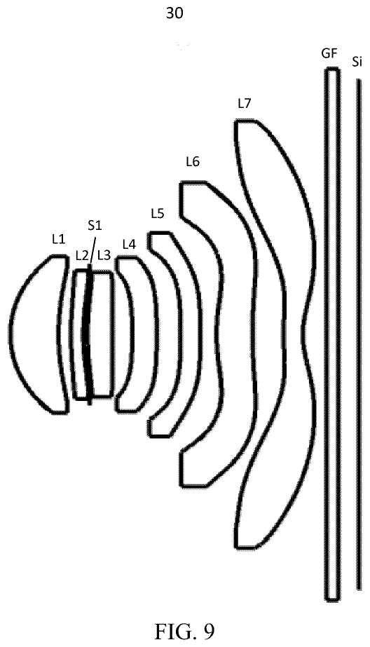

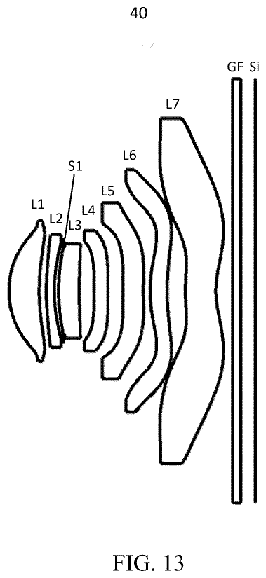

Referring to the drawings, the technical solutions of the present disclosure provide camera optical lenses 10, 20, 30 and 40. FIG. 1, FIG. 5, FIG. 9, FIG. 13, and FIG. 17 show camera optical lenses 10, 20, 30 and 40, and the camera optical lenses 10, 20, 30, and 40 include seven lenses. Specifically, the camera optical lenses 10, 20, 30, and 40 sequentially include from an object side to an image side: a first lens L1, a second lens L2, an aperture S1, a third lens L3, a fourth lens L4, a fifth lens L5, a sixth lens L6 and a seventh lens L7. An optical element such as an optical filter may be provided between the seventh lens L7 and an image surface Si.

The first lens L1 is made of plastic, the second lens L2 is made of glass or plastic, the third lens L3 is made of plastic, the fourth lens L4 is made of plastic, the fifth lens L5 is made of plastic, the sixth lens L6 is made of plastic, and the seventh lens L7 is made of plastic. The lenses may also be made of other materials.

It is defined that a focal length of the third lens L3 is f3, an on-axis thickness of the third lens L3 is d5, a central curvature radius of an object-side surface of the third lens L3 is R5, a central curvature radius of an image-side surface of the third lens L3 is R6, 0.12≤f3*d5/(R5+R6)≤0.30. Within the range of the relational expression, it is beneficial to control the shape of the third lens L3 and facilitate molding.

It is defined that a central curvature radius of an object-side surface of the sixth lens L6 is R11, a central curvature radius of an image-side surface of the sixth lens L6 is R12, a focal length of the sixth lens L6 is f6, 2.20≤(R11+R12)/f6≤4.00, the relational expression may reasonably control the surface profile of the sixth lens L6, which helps reduce the system sensitivity. Meanwhile, it may also reduce the stray light generated by the lens and improve the imaging quality of the lens.

It is defined that an on-axis thickness of the second lens L2 is d3, an on-axis distance from an image-side surface of the second lens L2 to the object-side surface of the third lens L3 is d4, an on-axis thickness of the third lens L3 is d5, 4.00≤(d3+d5)/d4≤8.50, which specifies a ratio of the sum of the on-axis thickness of the second lens L2 and the on-axis thickness of the third lens L3 to an air gap between the second lens L2 and the third lens L3. Within the range of the relational expression, it is beneficial to compress the total length of the optical system.

It is defined that a central curvature radius of an object-side surface of the seventh lens L7 is R13, a central curvature radius of an image-side surface of the seventh lens L7 is R14, and a following relational expression is satisfied: 2.00≤R13/R14≤3.50, which specifies the shape of the seventh lens. Within the range of the relational expression, it is beneficial to reduce the degree of deflection of light passing through the lens, and the aberration may be well reduced.

It is defined that an abbe number of the first lens L1 is v1, and an abbe number of the second lens L2 is v2, and a following relational expression is satisfied: 36.00≤v1−v2≤64.00, which specifies a difference between the abbe numbers of the first lens L1 and the second lens L2. Within the range, material properties may be effectively distributed, chromatic aberration may be effectively corrected, and chromatic aberration |LC|≤3 μm.

It is defined that the focal length of the camera optical lens 10 is f, a focal length of the fourth lens L4 is f4, a focal length of the fifth lens L5 is f5, and a following relational expression is satisfied: 2≤(f4−f5)/f≤5.00, by reasonably distributing the focal length of the distribution system, the system has better imaging quality and lower sensitivity.

When the above relational expressions are satisfied, the camera optical lenses 10, 20, 30, and 40 have good optical performance and may satisfy the design requirements of large aperture, wide-angle and ultra-thin; according to the characteristics of the camera optical lenses 10, 20, 30, and 40, the camera optical lenses 10, 20, 30, and 40 are particularly suitable for mobile phone camera lens assembly and the WEB camera lens composed of camera elements such as CCD and CMOS for high pixels.

Based on the above relational expressions and the achievable functions, the characteristics of each lens are further refined as follows. An object-side surface of the first lens L1 is convex in the paraxial region, an image-side surface of the first lens L1 is concave in the paraxial region, and the first lens L1 has positive refractive power. The object-side surface and the image-side surface of the first lens L1 may also be provided with other concave and convex distributions.

The focal length of the camera optical lens is f, and the focal length of the first lens L1 is f1, and a following relational expression is satisfied: 1.00≤f1/f≤1.13, by controlling the positive refractive power of the first lens L1 within a reasonable range, it is beneficial to correct the aberrations of the optical system.

It is defined that a central curvature radius of the object-side surface of the first lens L1 is R1, a central curvature radius of the image-side surface of the first lens L1 is R2, and a following relational expression is satisfied: −2.51≤(R1+R2)/(R1−R2)≤−2.01, which reasonably controls the shape of the first lens L1, so that the first lens L1 may effectively correct the spherical aberration of the system.

An on-axis thickness of the first lens L1 is d1, the total optical length from the object-side surface of the first lens to an image plane of the camera optical lens along an optic axis of the camera optical lens 10 is TTL, and a following relational expression is satisfied: 0.12≤d1/TTL≤0.14. Within the range of the relational expression, it is beneficial to achieve ultra-thinness.

An object-side surface of the second lens L2 is convex in the paraxial region, an image-side surface of the second lens L2 is concave in the paraxial region, and the second lens L2 has negative refractive power. The object-side surface and the image-side surface of the second lens L2 may also be provided with other concave and convex distributions.

A focal length of the second lens L2 is f2, and a following relational expression is satisfied: −5.10≤f2/f≤−2.44, by controlling the positive refractive power of the second lens L2 within a reasonable range, it is beneficial to correct the aberration of the optical system.

A central curvature radius of the object-side surface of the second lens L2 is R3, and a central curvature radius of the image-side surface of the second lens L2 is R4, a following relational expression is satisfied: 4.82≤(R3+R4)/(R3−R4)≤7.65, which specifies the shape of the second lens L2. Within the range, as lenses develop towards ultra-thinness and wide-angle, it is beneficial to correct the problem of axial chromatic aberration.

An on-axis thickness of the second lens L2 is d3, a total optical length from the object-side surface of the first lens to an image plane of the camera optical lens along an optic axis of the camera optical lens 10 is TTL, and a following relational expression is satisfied: 0.03≤d3/TTL≤0.04. Within the range of the relational expression, it is beneficial to achieve ultra-thinness.

An object-side surface of the third lens L3 is convex in the paraxial region, an image-side surface of the third lens L3 is concave in the paraxial region, and the third lens L3 has positive refractive power. The object-side surface and the image-side surface of the third lens L3 may also be provided with other concave and convex distributions.

A focal length of the third lens L3 is f3, and a following relational expression is satisfied: 2.06≤f3/f≤2.64, by reasonably distributing the refractive power, the system achieves better imaging quality and lower sensitivity.

A central curvature radius of the object-side surface of the third lens L3 is R5, and a central curvature radius of the image-side surface of the third lens L3 is R6, and a following relational expression is satisfied: −1.99≤(R5+R6)/(R5−R6)≤−1.34, which specifies the shape of the third lens L3. Within a specified range of the relational expression, the degree of deflection of light passing through the lens may be reduced, thereby effectively reducing aberration.

An on-axis thickness of the third lens L3 is d5, the total optical length from the object-side surface of the first lens to an image plane of the camera optical lens along an optic axis of the camera optical lens 10 is TTL, and a following relational expression is satisfied: 0.05≤d5/TTL≤0.08, which helps to the assembly of the lenses and effectively controls the lens thickness and the total length of the lens.

An object-side surface of the fourth lens L4 is concave in the paraxial region, an image-side surface of the fourth lens L4 is concave or convex in the paraxial region, and the fourth lens L4 has negative refractive power. The object-side surface and the image-side surface of the fourth lens L4 may also be provided with other concave and convex distributions.

A focal length of the fourth lens L4 is f4, and a following relational expression is satisfied: −5.65≤f4/f≤−2.36, by reasonably distributing the refractive power, the system has better imaging quality and lower sensitivity.

A central curvature radius of the object-side surface of the fourth lens L4 is R7, and a central curvature radius of the image-side surface of the fourth lens L4 is R8, and a following relational expression is satisfied. −2.94≤(R7+R8)/(R7−R8)≤−0.22, which specifies the shape of the fourth lens L4. Within the range, as lenses develop towards ultra-thinness and wide-angle, it is beneficial to correct the problem of off-axis aberration.

An on-axis thickness of the fourth lens L4 is d7, and a total optical length from the object-side surface of the first lens to an image plane of the camera optical lens along an optic axis of the camera optical lens is TTL, and a following relational expression is satisfied: 0.04≤d7/TTL≤0.07. Within the range of the relational expression, it is beneficial to achieve ultra-thinness.

An object-side surface of the fifth lens L5 is concave in the paraxial region, an image-side surface of the fifth lens L5 is concave in the paraxial region, and the fifth lens L5 has negative refractive power. The object-side surface and the image-side surface of the fifth lens L5 may also be provided with other concave and convex distributions.

A focal length of the fifth lens L5 is f5, and a following relational expression is satisfied: −9.06≤f5/f−4.36, and the limitation on the fifth lens L5 may effectively make the light angle of the camera optical lens 10 gentle and reduce the tolerance sensitivity.

A central curvature radius of the object-side surface of the fifth lens L5 is R9, a central curvature radius of the image-side surface of the fifth lens L5 is R10, and a following relational expression is satisfied: −1.72≤(R9+R10)/(R9−R10)≤0.96, which specifies the shape of the fifth lens L5. Within the range, as lenses develop towards ultra-thinness and wide-angle, it is beneficial to correct the problem of off-axis aberration.

An on-axis thickness of the fifth lens L5 is d9, and a following relational expression is satisfied: 0.05≤d9/TTL≤0.08, which helps to the assembly of the lenses and effectively controls the lens thickness and the total length of the lens.

An object-side surface of the sixth lens L6 is convex in the paraxial region, an image-side surface of the sixth lens L6 is concave in the paraxial region, and the sixth lens L6 has positive refractive power. The object-side surface and the image-side surface of the sixth lens L6 may also be provided with other concave and convex distributions.

A focal length of the sixth lens L6 is f6, and a following relational expression is satisfied: 1.35≤f6/f≤1.53, by reasonably distributing the refractive power, the system has better imaging quality and lower sensitivity.

A central curvature radius of the object-side surface of the sixth lens L6 is R11, a central curvature radius of the image-side surface of the sixth lens L6 is R12, and a following relational expression is satisfied: −1.66≤(R11+R12)/≤−1.33, which specifies the shape of the sixth lens L6. Within the range of the relational expression, as lenses develop towards ultra-thinness and wide-angle, it is beneficial to correct the problem of off-axis aberration.

An on-axis thickness of the sixth lens L6 is d11, a following relational expression is satisfied: 0.07≤d11/TTL≤0.11. Within the range of the relational expression, it is beneficial to achieve ultra-thinness.

An object-side surface of the seventh lens L7 is convex in the paraxial region, an image-side surface of the seventh lens L7 is concave in the paraxial region, and the seventh lens L7 has negative refractive power. The object-side surface and the image-side surface of the seventh lens L7 may also be provided with other concave and convex distributions.

A focal length of the seventh lens L7 is f7, and a following relational expression is satisfied: −1.64≤f7/f≤−0.84. By reasonably distributing the refractive power, the system has better imaging quality and lower sensitivity.

A central curvature radius of the object-side surface of the seventh lens L7 is R13, a central curvature radius of the image-side surface of the seventh lens L7 is R14, and a following relational expression is satidfied: 1.80≤(R13+R14)/≤3.00, which specifies the shape of the seventh lens L7. Within the range of the relational expression, as lenses develop towards ultra-thinness and wide-angle, it is beneficial to correct the problem of off-axis aberration.

An on-axis thickness of the seventh lens L7 is d13, and a following relational expression is satisfied: 0.05≤d13/TTL≤0.13. Within the range of the relational expression, it is beneficial to achieve ultra-thinness.

The camera optical lens of the present disclosure will be described below by way of Examples. The reference signs recited in each embodiment are shown below. The units of the focal length, the on-axis distance, the central curvature radius, and the on-axis thickness are mm.

TTL denotes a total optical length from the object-side surface of the first lens to an image plane of the camera optical lens along an optic axis (the on-axis distance from the object-side surface of the first lens L1 to the image plane Si), and its unit is mm.

F-number FNO refers to a ratio of the effective focal length of the camera optical lens to the entrance pupil diameter of the camera optical lens.

Image height IH at 1.0 field of view refers to a field height corresponding to the effective pixels of the sensor (i.e., half of the diagonal length of the effective pixel area of the sensor);
Field of view FOV at 1.0 field of view refers to a field of view corresponding to the effective pixel of the sensor;
Image height IHm at MIC (Microscope Infrared Spectroscopy) field of view refers to a field height expanded beyond 1.0 to prevent assembly deviation;
Field of view FOVm at MIC field of view refers to a field of view corresponding to the image height of the MIC field of view;

Optionally, the object-side surface and/or the image-side surface of the lens may be further provided with an inflection point and/or a stationary point, so as to meet high-quality imaging requirements.

The technical solutions of the present disclosure will be described in detail in four Examples, the technical effect of the disclosure cannot be realized when the range of the above relational expression is exceeded.

### Example 1

Table 1 shows design data of the camera optical lens 10 according to Example 1 of the present disclosure.

TABLE 1

| | R | d | | nd | | νd | |
|---|---|---|---|---|---|---|---|
| S1 | ∞ | d0= | −1.471 | | | | |
| R1 | 1.852 | d1= | 0.775 | nd1 | 1.4959 | ν1 | 81.65 |
| R2 | 4.319 | d2= | 0.276 | | | | |
| R3 | 5.001 | d3= | 0.230 | nd2 | 1.6700 | ν2 | 19.39 |
| R4 | 3.844 | d4= | 0.085 | | | | |
| R5 | 5.183 | d5= | 0.305 | nd3 | 1.5444 | ν3 | 55.82 |
| R6 | 16.755 | d6= | 0.393 | | | | |
| R7 | −21.024 | d7= | 0.285 | nd4 | 1.6700 | ν4 | 19.39 |
| R8 | 33.029 | d8= | 0.345 | | | | |
| R9 | −311.695 | d9= | 0.376 | nd5 | 1.6153 | ν5 | 25.94 |
| R10 | 23.720 | d10= | 0.227 | | | | |
| R11 | 3.387 | d11= | 0.450 | nd6 | 1.5661 | ν6 | 37.71 |
| R12 | 19.468 | d12= | 0.460 | | | | |
| R13 | 4.168 | d13= | 0.580 | nd7 | 1.5444 | ν7 | 55.82 |
| R14 | 1.646 | d14= | 0.427 | | | | |
| R15 | ∞ | d15= | 0.210 | ndg | 1.5168 | νg | 64.17 |
| R16 | ∞ | d16= | 0.566 | | | | |

The meaning of each reference sign is as follows.
S1: aperture;
R: central curvature radius of an optical surface;
R1: central curvature radius of the object-side surface of the first lens L1;
R2: central curvature radius of the image-side surface of the first lens L1;
R3: central curvature radius of the object-side surface of the second lens L2;
R4: central curvature radius of the image-side surface of the second lens L2;
R5: central curvature radius of the object-side surface of the third lens L3;
R6: central curvature radius of the image-side surface of the third lens L3;
R7: central curvature radius of the object-side surface of the fourth lens L4;
R8: central curvature radius of the image-side surface of the fourth lens L4;
R9: central curvature radius of the object-side surface of the fifth lens L5;
R10: central curvature radius of the image-side surface of the fifth lens L5;
R11: central curvature radius of the object-side surface of the sixth lens L6;
R12: central curvature radius of the image-side surface of the sixth lens L6;
R13: central curvature radius of the object-side surface of the seventh lens L7;
R14: central curvature radius of the image-side surface of the seventh lens L7;
R15: curvature radius of the object-side surface of the optical filter GF;
R16: curvature radius of the image-side surface of the optical filter GF;
d: on-axis thickness of lenses and an on-axis distance between lenses;
d0: on-axis distance from the aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the seventh lens L7;
d13: on-axis thickness of the seventh lens L7;
d14: on-axis distance from the image-side surface of the seventh lens L7 to the object-side surface of the eighth lens L8;
D15: on-axis thickness of the optical filter GF;
d16: on-axis distance from the image-side surface of the optical filter GF to the image surface;
nd: refractive index of d line;
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
ndg: refractive index of d line of the optical filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
v7: abbe number of the seventh lens L7; and
vg: abbe number of the optical filter GF.

Table 2 and Table 3 show aspheric surface data of each lens in the camera optical lens 10 according to Example 1 of the present disclosure.

TABLE 2

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −1.1839E−01 | 3.7201E−04 | 1.3492E−03 | 1.0286E−03 | −9.8305E−03 | 1.8730E−02 | −1.8102E−02 |
| R2 | −4.5053E+00 | −3.0473E−03 | −4.5261E−03 | 1.1756E−02 | −2.4373E−02 | 2.7063E−02 | −1.8741E−02 |
| R3 | −1.0439E+01 | −4.2380E−02 | 1.3735E−02 | −1.8703E−02 | 6.3024E−02 | −9.5851E−02 | 8.6461E−02 |
| R4 | −5.2318E+00 | −3.4065E−02 | −1.9168E−02 | 1.0436E−01 | −2.9913E−01 | 5.7683E−01 | −6.9130E−01 |
| R5 | −3.5372E−01 | 8.3893E−03 | −4.7614E−03 | −5.2797E−02 | 1.1834E−01 | −1.4630E−01 | 8.1300E−02 |
| R6 | 7.2171E+01 | 1.3857E−02 | −6.8323E−02 | 3.4273E−01 | −1.0595E+00 | 1.9526E+00 | −2.2333E+00 |
| R7 | −2.4470E+01 | −6.6551E−02 | −8.5231E−02 | 5.5484E−01 | −2.2705E+00 | 5.7952E+00 | −9.7862E+00 |
| R8 | −1.0000E+02 | −5.4769E−02 | −7.7211E−02 | 3.8574E−01 | −1.0694E+00 | 1.8451E+00 | −2.1048E+00 |
| R9 | −9.9748E+01 | −6.5548E−02 | −3.0910E−03 | 6.3511E−02 | −8.9696E−02 | 6.6441E−02 | −4.5615E−02 |
| R10 | −8.5132E+01 | −8.1077E−02 | −9.4364E−02 | 2.1184E−01 | −2.1946E−01 | 1.4411E−01 | −6.2811E−02 |
| R11 | 6.5543E−02 | 5.8058E−02 | −1.9398E−01 | 2.6322E−01 | −2.8369E−01 | 2.2694E−01 | −1.3284E−01 |
| R12 | −9.9477E+01 | 8.6473E−02 | −7.5389E−02 | 5.9087E−02 | −6.4538E−02 | 5.5272E−02 | −3.2124E−02 |
| R13 | 3.3154E−03 | −2.1353E−01 | 8.9638E−02 | −2.5292E−02 | 5.4366E−03 | −8.7726E−04 | 1.0277E−04 |
| R14 | −9.8827E−01 | −2.3141E−01 | 1.3232E−01 | −6.6456E−02 | 2.6143E−02 | −7.7048E−03 | 1.6683E−03 |

TABLE 3

| | Aspheric Coefficient | | | | | | | |
|---|---|---|---|---|---|---|---|---|
| | A16 | A18 | A20 | A22 | A24 | A26 | A28 | A30 |
| R1 | 9.5151E−03 | −2.6258E−03 | 2.9061E−04 | 0.0000E+00 | 0.0000E+00 | 0.0000E+00 | 0.0000E+00 | 0.0000E+00 |
| R2 | 7.7449E−03 | −1.7505E−03 | 1.6697E−04 | 0.0000E+00 | 0.0000E+00 | 0.0000E+00 | 0.0000E+00 | 0.0000E+00 |
| R3 | −4.6490E−02 | 1.3699E−02 | −1.6728E−03 | 0.0000E+00 | 0.0000E+00 | 0.0000E+00 | 0.0000E+00 | 0.0000E+00 |
| R4 | 4.9970E−01 | −2.0047E−01 | 3.4481E−02 | 0.0000E+00 | 0.0000E+00 | 0.0000E+00 | 0.0000E+00 | 0.0000E+00 |
| R5 | 6.7268E−03 | −2.9169E−02 | 1.0014E−02 | 0.0000E+00 | 0.0000E+00 | 0.0000E+00 | 0.0000E+00 | 0.0000E+00 |
| R6 | 1.5464E+00 | −5.9416E−01 | 9.7560E−02 | 0.0000E+00 | 0.0000E+00 | 0.0000E+00 | 0.0000E+00 | 0.0000E+00 |
| R7 | 1.1072E+01 | −8.3042E+00 | 3.9587E+00 | −1.0857E+00 | 1.3041E−01 | 0.0000E+00 | 0.0000E+00 | 0.0000E+00 |
| R8 | 1.6079E+00 | −8.1199E−01 | 2.5947E−01 | −4.7348E−02 | 3.7445E−03 | 0.0000E+00 | 0.0000E+00 | 0.0000E+00 |
| R9 | 4.0892E−02 | −3.2922E−02 | 1.7439E−02 | −5.5571E−03 | 9.7556E−04 | −7.2756E−05 | 0.0000E+00 | 0.0000E+00 |
| R10 | 1.7885E−02 | −3.1626E−03 | 3.1277E−04 | −1.3153E−05 | 0.0000E+00 | 0.0000E+00 | 0.0000E+00 | 0.0000E+00 |
| R11 | 5.6859E−02 | −1.7767E−02 | 4.0245E−03 | −6.5074E−04 | 7.2991E−05 | −5.3857E−06 | 2.3485E−07 | −4.5833E−09 |
| R12 | 1.2868E−02 | −3.6309E−03 | 7.2810E−04 | −1.0313E−04 | 1.0075E−05 | −6.4519E−07 | 2.4351E−08 | −4.1021E−10 |
| R13 | −8.5784E−06 | 5.0165E−07 | −1.9783E−08 | 4.7707E−10 | −5.3267E−12 | 0.0000E+00 | 0.0000E+00 | 0.0000E+00 |
| R14 | −2.6271E−04 | 2.9838E−05 | −2.4131E−06 | 1.3571E−07 | −5.0781E−09 | 1.1618E−10 | −1.3499E−12 | 4.3755E−15 |

For convenience, the aspheric surface of each lens surface uses the aspheric surface shown in following formula (1). However, the present disclosure is not limited to the aspheric polynomial form shown in formula (1).

$$y = ( {x}^{2} / R ) / [ 1 + \{ 1 - ( k + 1 ) ( {x}^{2} / {R}^{2} ) \} 1 / 2 ] + A 4 {x}^{4} + A 6 {x}^{6} + A 8 {x}^{8} + A 10 {x}^{10} + A 12 {x}^{12} + A 14 {x}^{14} + A 16 {x}^{16} + A 18 {x}^{18} + A 20 {x}^{20} + A 22 {x}^{22} + A 24 {x}^{24} + A 26 {x}^{26} + A 28 {x}^{28} + A 30 {x}^{30} \qquad ( 1 )$$

k is a conic coefficient, A4, A6, A8, A10, A12, A14, A16, A18, A20, A22, A24, A26, A28 and A30 are aspheric coefficients, c is a curvature at a center of an optical surface, ris a vertical distance between a point on an aspheric curve and an optical axis, and z is an aspheric depth (a vertical distance between a point on the aspherical surface having a distance r from the optical axis, and a tangent plane tangent to a vertex on the aspherical optical axis).

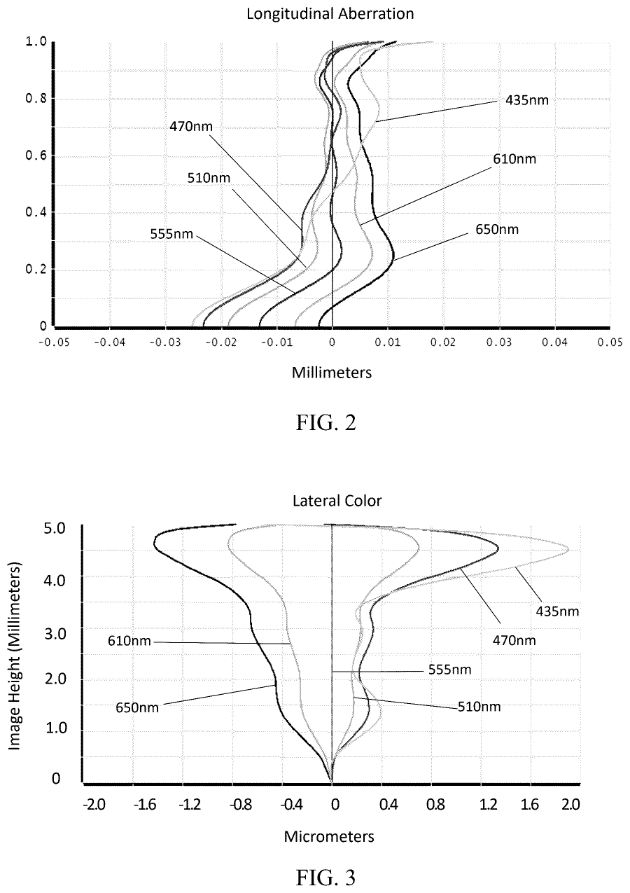

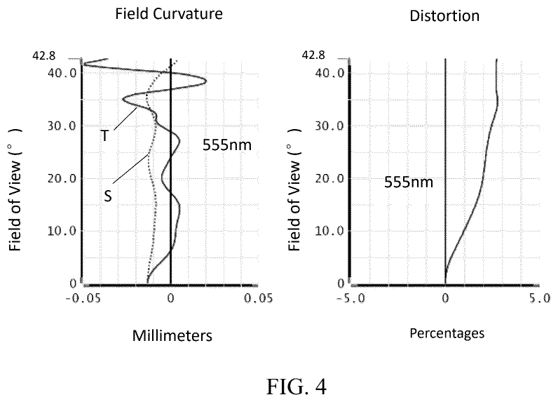

FIG. 2 and FIG. 3 respectively show longitudinal aberration and lateral color of light with wavelengths of 650 nm, 610 nm, 555 nm, 510 nm, 470 nm, and 435 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in a sagittal direction, and Tis a field curvature in a meridian direction.

In this Example, an entrance pupil diameter ENPD of the camera optical lens is 2.831 mm, an image height IH at 1.0 field of view is 5.000 mm, a field of view FOV at 1.0 field of view is 85.52°, an image height IHm at MIC field of view is 5.200 mm, and a field of view FOVm at MIC field of view is 88.11°. The camera optical lens 10 satisfies the design requirements of large aperture, wide-angle and ultra-thinness, and the on-axis and off-axis chromatic aberration thereof are fully corrected, and has good optical performance.

### Example 2

Example 2 is substantially the same as Example 1, and the reference signs have the same meaning as Example 1, and only differences are listed below.

In this Example, the image-side surface of the fourth lens L4 is convex in the paraxial region, and Table 4 shows design data of the camera optical lens 20 according to Example 2 of the present disclosure.

TABLE 4

| | R | d | | nd | | νd | |
|---|---|---|---|---|---|---|---|
| S1 | ∞ | d0= | −1.511 | | | | |
| R1 | 2.001 | d1= | 0.855 | nd1 | 1.4959 | ν1 | 81.65 |
| R2 | 5.956 | d2= | 0.195 | | | | |
| R3 | 5.163 | d3= | 0.205 | nd2 | 1.6856 | ν2 | 18.40 |
| R4 | 3.844 | d4= | 0.163 | | | | |
| R5 | 5.271 | d5= | 0.448 | nd3 | 1.5444 | ν3 | 55.82 |
| R6 | 15.933 | d6= | 0.415 | | | | |
| R7 | −9.043 | d7= | 0.386 | nd4 | 1.6700 | ν4 | 19.39 |
| R8 | −23.679 | d8= | 0.445 | | | | |
| R9 | −36.482 | d9= | 0.424 | nd5 | 1.6153 | ν5 | 25.94 |
| R10 | 177.934 | d10= | 0.336 | | | | |
| R11 | 3.185 | d11= | 0.540 | nd6 | 1.5661 | ν6 | 37.71 |
| R12 | 12.865 | d12= | 0.481 | | | | |
| R13 | 6.024 | d13= | 0.342 | nd7 | 1.5444 | ν7 | 55.82 |
| R14 | 1.721 | d14= | 0.427 | | | | |
| R15 | ∞ | d15= | 0.210 | ndg | 1.5168 | νg | 64.17 |
| R16 | ∞ | d16= | 0.355 | | | | |

Table 5 and Table 6 show aspheric surface data of each lens in the camera optical lens 20 according to Example 2 of the present disclosure.

TABLE 5

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −6.5681E−02 | 9.4526E−04 | −2.5377E−03 | 8.1973E−03 | −1.5314E−02 | 1.6830E−02 | −1.1408E−02 |
| R2 | −3.4797E+00 | −7.5703E−03 | 3.5890E−03 | −3.0070E−03 | 4.4687E−04 | 4.5979E−04 | −5.9272E−04 |
| R3 | −9.6066E+00 | −3.8762E−02 | 1.5031E−02 | 2.8764E−03 | −1.3966E−02 | 2.2625E−02 | −2.1100E−02 |
| R4 | −4.9023E+00 | −3.8158E−02 | 8.9667E−03 | 1.7598E−02 | −5.0187E−02 | 8.1979E−02 | −8.1562E−02 |
| R5 | −3.1841E+00 | −7.3492E−03 | −3.0737E−03 | −1.2470E−02 | 2.7896E−02 | −3.7703E−02 | 3.1965E−02 |
| R6 | 2.0692E+01 | −3.7061E−03 | −8.0153E−03 | 1.6906E−02 | 4.7199E−02 | 7.5809E−02 | −7.6987E−02 |
| R7 | −1.2267E+02 | −7.7956E−02 | 2.6839E−02 | −7.5409E−02 | 1.3907E−01 | −1.9209E−01 | 1.7504E−01 |
| R8 | −8.1861E+01 | −5.0878E−02 | 8.3331E−03 | −8.3973E−03 | −7.8010E−03 | 2.0957E−02 | −2.0090E−02 |
| R9 | −2.3076E+03 | −7.1568E−02 | 4.5561E−02 | −6.0339E−02 | 7.0723E−02 | −7.0811E−02 | 4.6767E−02 |
| R10 | −2.8656E+04 | −9.3814E−02 | 2.2695E−02 | 1.4506E−02 | −2.2347E−02 | 1.2568E−02 | −4.1517E−03 |
| R11 | −9.3191E−01 | −1.8310E−03 | −6.9227E−02 | 5.4717E−02 | −2.3853E−02 | 1.8367E−03 | 4.4629E−03 |
| R12 | −1.0662E+02 | 1.1173E−01 | −1.3166E−01 | 9.0102E−02 | −4.5082E−02 | 1.6484E−02 | −4.3786E−03 |
| R13 | 7.3234E−03 | −1.2834E−01 | 5.6959E−03 | 3.8202E−02 | −2.6378E−02 | 9.5311E−03 | −2.2078E−03 |
| R14 | −9.8144E−01 | −1.9587E−01 | 8.6051E−02 | −2.9253E−02 | 7.9535E−03 | −1.8244E−03 | 3.5474E−04 |

TABLE 6

| | Aspheric Coefficient | | | | | | | |
|---|---|---|---|---|---|---|---|---|
| | A16 | A18 | A20 | A22 | A24 | A26 | A28 | A30 |
| R1 | 4.5993E−03 | −1.0192E−03 | 9.3200E−05 | 0.0000E+00 | 0.0000E+00 | 0.0000E+00 | 0.0000E+00 | 0.0000E+00 |
| R2 | 2.9418E−04 | −7.4202E−05 | 7.6221E−06 | 0.0000E+00 | 0.0000E+00 | 0.0000E+00 | 0.0000E+00 | 0.0000E+00 |
| R3 | 1.1959E−02 | −3.7673E−03 | 5.0580E−04 | 0.0000E+00 | 0.0000E+00 | 0.0000E+00 | 0.0000E+00 | 0.0000E+00 |
| R4 | 4.9715E−02 | −1.7054E−02 | 2.5254E−03 | 0.0000E+00 | 0.0000E+00 | 0.0000E+00 | 0.0000E+00 | 0.0000E+00 |
| R5 | −1.4957E−02 | 3.1501E−03 | −9.6329E−05 | 0.0000E+00 | 0.0000E+00 | 0.0000E+00 | 0.0000E+00 | 0.0000E+00 |
| R6 | 4.8512E−02 | −1.7240E−02 | 2.6255E−03 | 0.0000E+00 | 0.0000E+00 | 0.0000E+00 | 0.0000E+00 | 0.0000E+00 |
| R7 | −1.0098E−01 | 3.3406E−02 | −4.9497E−03 | 0.0000E+00 | 0.0000E+00 | 0.0000E+00 | 0.0000E+00 | 0.0000E+00 |
| R8 | 1.0407E−02 | −2.8717E−03 | 3.2909E−04 | 0.0000E+00 | 0.0000E+00 | 0.0000E+00 | 0.0000E+00 | 0.0000E+00 |
| R9 | −1.9036E−02 | 4.3485E−03 | −4.3020E−04 | 0.0000E+00 | 0.0000E+00 | 0.0000E+00 | 0.0000E+00 | 0.0000E+00 |
| R10 | 8.6318E−04 | −1.0391E−04 | 5.4548E−06 | 0.0000E+00 | 0.0000E+00 | 0.0000E+00 | 0.0000E+00 | 0.0000E+00 |
| R11 | −2.9995E−03 | 1.0129E−03 | −2.0662E−04 | 2.5623E−05 | −1.7786E−06 | 5.2994E−08 | 0.0000E+00 | 0.0000E+00 |
| R12 | 8.3457E−04 | −1.1165E−04 | 1.0117E−05 | −5.8520E−07 | 1.9296E−08 | −2.7269E−10 | 0.0000E+00 | 0.0000E+00 |
| R13 | 3.5095E−04 | −3.9421E−05 | 3.1567E−06 | −1.7884E−07 | 6.9832E−09 | −1.7795E−10 | 2.6457E−12 | −1.7232E−14 |
| R14 | −5.5886E−05 | 6.7778E−06 | −6.1044E−07 | 3.9733E−08 | −1.8104E−09 | 5.4762E−11 | −9.8889E−13 | 8.0796E−15 |

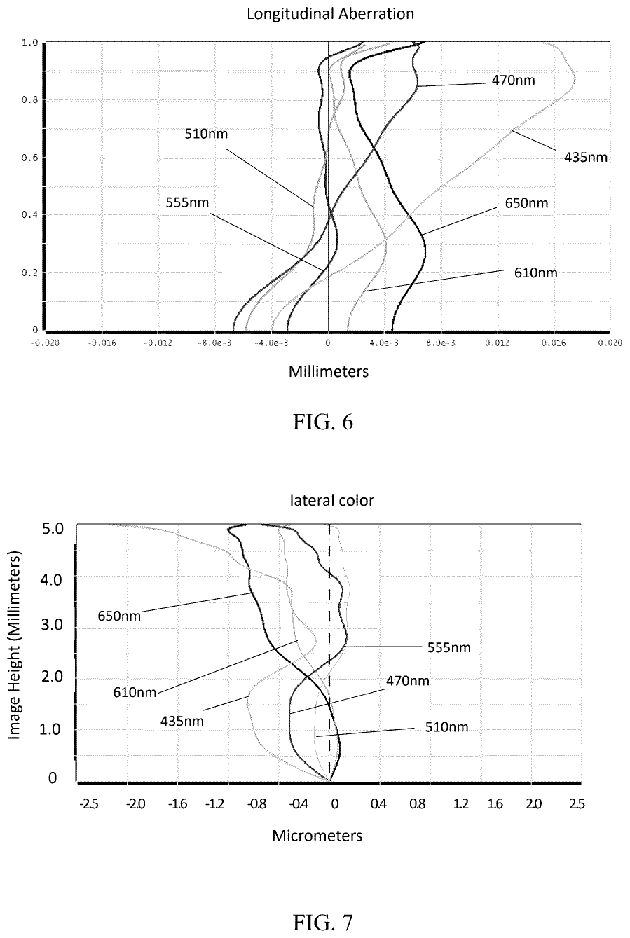

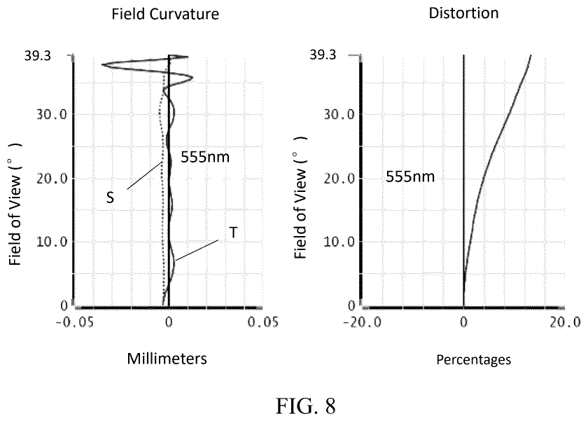

FIG. 6 and FIG. 7 respectively show longitudinal aberration and lateral color of light with wavelengths of 650 nm, 610 nm, 555 nm, 510 nm, 470 nm, and 435 nm after passing through the camera optical lens 20 according to Example 2. FIG. 8 shows field curvature and distortion of light with a wavelength of 555 nm after passing through the camera optical lens 20 according to Example 2, the field curvature S in FIG. 8 is a field curvature in a sagittal direction, and Tis a field curvature in a meridian direction.

In this Example, an entrance pupil diameter ENPD of the camera optical lens 20 is 2.915 mm, an image height IH at 1.0 field of view is 5.000 mm, a field of view FOV at 1.0 field of view is 78.53°, an image height IHm at MIC field of view is 5.200 mm, and a field of view FOVm at MIC field of view is 80.91°. The camera optical lens 20 satisfies the design requirements of large aperture, wide-angle and ultra-thinness, and the on-axis and off-axis chromatic aberration thereof are fully corrected, and has good optical performance.

### Example 3

Example 3 is substantially the same as Example 1, the reference signs have the same meaning as Example 1, and only differences are listed below.

In this Example, the image-side surface of the fourth lens L4 is convex in the paraxial region.

Table 7 shows design data of the camera optical lens 30 according to Example 3 of the present disclosure.

TABLE 7

| | R | d | | nd | | νd | |
|---|---|---|---|---|---|---|---|
| S1 | ∞ | d0= | −1.408 | | | | |
| R1 | 1.909 | d1= | 0.860 | nd1 | 1.4959 | ν1 | 81.65 |
| R2 | 4.857 | d2= | 0.220 | | | | |
| R3 | 5.963 | d3= | 0.214 | nd2 | 1.6856 | ν2 | 18.40 |
| R4 | 4.174 | d4= | 0.077 | | | | |
| R5 | 5.709 | d5= | 0.440 | nd3 | 1.5444 | ν3 | 55.82 |
| R6 | 38.976 | d6= | 0.358 | | | | |
| R7 | −10.011 | d7= | 0.429 | nd4 | 1.6700 | ν4 | 19.39 |
| R8 | −20.339 | d8= | 0.428 | | | | |
| R9 | −18.276 | d9= | 0.349 | nd5 | 1.6153 | ν5 | 25.94 |
| R10 | −69.379 | d10= | 0.292 | | | | |
| R11 | 3.942 | d11= | 0.640 | nd6 | 1.5661 | ν6 | 37.71 |
| R12 | 28.006 | d12= | 0.551 | | | | |
| R13 | 5.541 | d13= | 0.337 | nd7 | 1.5444 | ν7 | 55.82 |
| R14 | 1.730 | d14= | 0.427 | | | | |
| R15 | ∞ | d15= | 0.210 | ndg | 1.5168 | νg | 64.17 |
| R16 | ∞ | d16= | 0.369 | | | | |

Table 8 and Table 9 show aspheric surface data of each lens in the camera optical lens 30 according to Example 3 of the present disclosure.

TABLE 8

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.9376E−02 | 1.1194E−03 | −2.2909E−03 | 6.7590E−03 | −1.0759E−02 | 1.0612E−02 | −6.5037E−03 |
| R2 | −2.4183E+00 | −5.3172E−03 | 1.9103E−03 | −3.8221E−03 | 4.6391E−03 | −5.1524E−03 | 3.5643E−03 |
| R3 | −1.4899E+01 | −4.0371E−02 | 9.7497E−03 | 1.1761E−02 | −2.3149E−02 | 3.4063E−02 | −3.3308E−02 |
| R4 | −7.0730E+00 | −3.8359E−02 | −5.1491E−03 | 5.7315E−02 | −1.6205E−01 | 3.0768E−01 | −3.6296E−01 |
| R5 | −8.3596E+00 | −4.0447E−03 | −2.1335E−02 | 4.1113E−02 | −1.2649E−01 | 2.5087E−01 | −3.0581E−01 |
| R6 | −3.4181E+02 | −3.4365E−03 | −1.4917E−02 | 5.1037E−02 | −1.4921E−01 | 2.5782E−01 | −2.8016E−01 |
| R7 | −1.7294E+02 | −7.9207E−02 | 3.0306E−02 | −1.0944E−01 | 2.4930E−01 | −4.0246E−01 | 4.1603E−01 |
| R8 | 8.2867E+01 | −4.6686E−02 | 2.5060E−03 | −9.0353E−03 | 4.6911E−03 | 4.4089E−04 | −2.7359E−03 |
| R9 | −1.0946E+02 | −6.0094E−02 | 3.5134E−03 | 3.1121E−02 | −6.2378E−02 | 5.6060E−02 | −3.0763E−02 |
| R10 | −8.6782E−02 | −3.2819E−05 | 5.0249E−02 | −5.5635E−02 | 3.1414E−02 | −1.0188E−02 | 1.9104E−03 |
| R11 | −4.7490E−01 | −1.8911E−02 | −6.5739E−02 | 6.7388E−02 | −4.3694E−02 | 1.8996E−02 | −5.6305E−03 |
| R12 | −3.4110E+02 | 7.5218E−02 | −9.7818E−02 | 7.1211E−02 | −3.7674E−02 | 1.4395E−02 | −3.9768E−03 |
| R13 | 7.3234E−03 | −1.3114E−01 | 1.1732E−02 | 3.4642E−02 | −2.6366E−02 | 1.0339E−02 | −2.6181E−03 |
| R14 | −9.7369E−01 | −1.8587E−01 | 7.6682E−02 | −2.1967E−02 | 3.8771E−03 | −2.5872E−04 | −6.2880E−05 |

TABLE 9

| | Aspheric Coefficient | | | | | | | |
|---|---|---|---|---|---|---|---|---|
| | A16 | A18 | A20 | A22 | A24 | A26 | A28 | A30 |
| R1 | 2.3309E−03 | −4.3625E−04 | 2.7548E−05 | 0.0000E+00 | 0.0000E+00 | 0.0000E+00 | 0.0000E+00 | 0.0000E+00 |
| R2 | −1.5237E−03 | 3.7568E−04 | −4.2447E−05 | 0.0000E+00 | 0.0000E+00 | 0.0000E+00 | 0.0000E+00 | 0.0000E+00 |
| R3 | 2.0354E−02 | −6.9685E−03 | 1.0229E−03 | 0.0000E+00 | 0.0000E+00 | 0.0000E+00 | 0.0000E+00 | 0.0000E+00 |
| R4 | 2.5842E−01 | −1.0208E−01 | 1.7255E−02 | 0.0000E+00 | 0.0000E+00 | 0.0000E+00 | 0.0000E+00 | 0.0000E+00 |
| R5 | 2.2543E−01 | −9.2568E−02 | 1.6401E−02 | 0.0000E+00 | 0.0000E+00 | 0.0000E+00 | 0.0000E+00 | 0.0000E+00 |
| R6 | 1.8644E−01 | −6.9411E−02 | 1.1097E−02 | 0.0000E+00 | 0.0000E+00 | 0.0000E+00 | 0.0000E+00 | 0.0000E+00 |
| R7 | −2.6626E−01 | 9.5723E−02 | −1.4952E−02 | 0.0000E+00 | 0.0000E+00 | 0.0000E+00 | 0.0000E+00 | 0.0000E+00 |
| R8 | 2.0988E−03 | −7.5442E−04 | 1.1176E−04 | 0.0000E+00 | 0.0000E+00 | 0.0000E+00 | 0.0000E+00 | 0.0000E+00 |
| R9 | 1.0752E−02 | −2.2053E−03 | 1.9994E−04 | 0.0000E+00 | 0.0000E+00 | 0.0000E+00 | 0.0000E+00 | 0.0000E+00 |
| R10 | −1.9238E−04 | 8.0458E−06 | 0.0000E+00 | 0.0000E+00 | 0.0000E+00 | 0.0000E+00 | 0.0000E+00 | 0.0000E+00 |
| R11 | 1.1477E−03 | −1.5732E−04 | 1.3149E−05 | −5.0110E−07 | 0.0000E+00 | 0.0000E+00 | 0.0000E+00 | 0.0000E+00 |
| R12 | 7.9417E−04 | −1.1327E−04 | 1.1202E−05 | −7.2643E−07 | 2.7671E−08 | −4.6810E−10 | 0.0000E+00 | 0.0000E+00 |
| R13 | 4.6029E−04 | −5.7953E−05 | 5.2792E−06 | −3.4587E−07 | 1.5912E−08 | −4.8833E−10 | 8.9835E−12 | −7.4970E−14 |
| R14 | 2.2802E−05 | −3.8167E−06 | 4.1199E−07 | −3.0427E−08 | 1.5322E−09 | −5.0370E−11 | 9.7478E−13 | −8.4198E−15 |

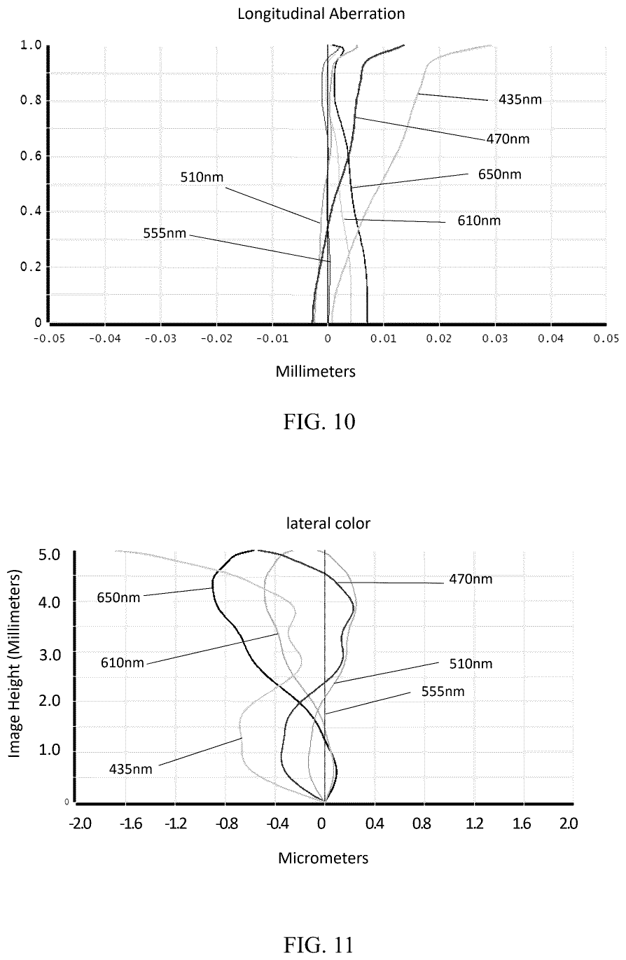

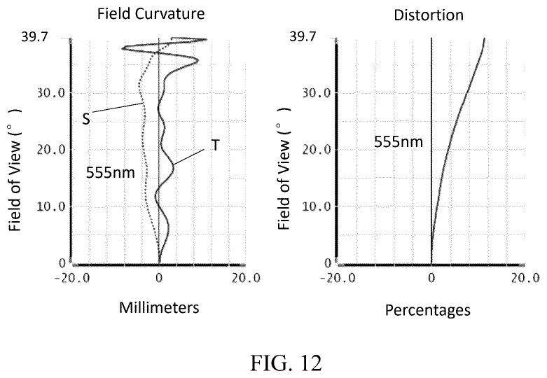

FIG. 10 and FIG. 11 respectively show longitudinal aberration and lateral color of light with wavelengths of 650 nm, 610 nm, 555 nm, 510 nm, 470 nm, and 435 nm after passing through the camera optical lens 30 according to Example 3. FIG. 12 shows field curvature and distortion of light with a wavelength of 555 nm after passing through the camera optical lens 30 according to Example 3, the field curvature S in FIG. 12 is a field curvature in a sagittal direction, and T is a field curvature in a meridian direction.

In this Example, an entrance pupil diameter ENPD of the camera optical lens 30 is 2.838 mm, an image height IH at 1.0 field of view is 5.000 mm, a field of view FOV at 1.0 field of view is 79.38°, an image height IHm at MIC field of view is 5.200 mm, and a field of view FOVm at MIC field of view is 81.82°. The camera optical lens 30 satisfies the design requirements of large aperture, wide-angle and ultra-thinness, and the on-axis and off-axis chromatic aberration thereof are fully corrected, and has good optical performance.

### Example 4

Example 4 is substantially the same as Example 1, and the reference signs have the same meaning as Example 1, and only differences are listed below.

Table 10 shows design data of the camera optical lens 40 according to Example 4 of the present disclosure.

TABLE 10

| | R | d | | nd | | νd | |
|---|---|---|---|---|---|---|---|
| S1 | ∞ | d0= | −1.459 | | | | |
| R1 | 2.010 | d1= | 0.803 | nd1 | 1.5444 | ν1 | 55.82 |
| R2 | 5.505 | d2= | 0.158 | | | | |
| R3 | 4.326 | d3= | 0.216 | nd2 | 1.6700 | ν2 | 19.39 |
| R4 | 2.840 | d4= | 0.144 | | | | |
| R5 | 4.251 | d5= | 0.486 | nd3 | 1.5444 | ν3 | 55.82 |
| R6 | 13.916 | d6= | 0.460 | | | | |
| R7 | −10.238 | d7= | 0.372 | nd4 | 1.6700 | ν4 | 19.39 |
| R8 | 51.301 | d8= | 0.292 | | | | |
| R9 | −711.756 | d9= | 0.493 | nd5 | 1.6153 | ν5 | 25.94 |
| R10 | 14.696 | d10= | 0.151 | | | | |
| R11 | 3.201 | d11= | 0.488 | nd6 | 1.5661 | ν6 | 37.71 |
| R12 | 12.953 | d12= | 0.424 | | | | |
| R13 | 4.069 | d13= | 0.814 | nd7 | 1.5444 | ν7 | 55.82 |
| R14 | 2.034 | d14= | 0.427 | | | | |
| R15 | ∞ | d15= | 0.210 | ndg | 1.5168 | νg | 64.17 |
| R16 | ∞ | d16= | 0.437 | | | | |

Table 11 and Table 12 show aspheric surface data of each lens in the camera optical lens 40 according to Example 4 of the present disclosure.

TABLE 11

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.1691E−02 | 3.1726E−03 | −7.1806E−03 | 2.7895E−02 | −5.5938E−02 | 6.6599E−02 | −4.8321E−02 |
| R2 | −5.0267E+00 | −1.0337E−02 | 4.6007E−03 | 9.8414E−03 | −3.0176E−02 | 3.5771E−02 | −2.4952E−02 |
| R3 | −1.6010E+01 | −4.8038E−02 | 2.5063E−02 | −1.5982E−03 | −9.0746E−03 | 8.7526E−03 | −2.5611B−03 |
| R4 | −3.5077E+00 | −4.4226E−02 | 1.6152E−02 | 2.9822E−02 | −8.2792E−02 | 1.0735E−01 | −7.8751E−02 |
| R5 | 4.3149E−01 | 3.8927E−03 | 2.6016E−03 | −5.3877E−02 | 1.5031E−01 | −2.7005E−01 | 2.9592E−01 |
| R6 | 3.8460E+01 | 5.2218E−03 | −4.2801E−03 | 2.0449E−02 | −7.3807E−02 | 1.2420E−01 | −1.2573E−01 |
| R7 | −5.3315E+01 | −8.6463E−02 | 1.0239E−01 | −4.2771E−01 | 1.0268E+00 | −1.5661E+00 | 1.4993E+00 |
| R8 | −1.3533E+01 | −6.6330E−02 | 5.4507E−02 | −1.5157E−01 | 2.4641E−01 | −2.5318E−01 | 1.6199E−01 |
| R9 | 1.4185E+03 | −4.5180E−02 | 3.7064E−02 | −1.1748E−01 | 2.1385E−01 | −2.5291E−01 | 1.9458E−01 |
| R10 | 2.6750E+01 | −5.8454E−02 | −6.1369E−02 | 8.3317E−02 | 6.1616E−02 | 2.9593E−02 | −9.1044E−03 |
| R11 | 2.3739E−02 | 1.4609E−02 | −7.8480E−02 | 6.1110E−02 | −2.4229E−02 | −3.6822E−03 | 9.0303E−03 |
| R12 | −2.1659E+02 | 3.5610E−02 | −2.8972E−02 | 1.6699E−02 | −5.9150E−03 | −2.2483E−03 | 3.3174E−03 |
| R13 | −1.3679E−02 | −1.2545E−01 | −1.6332E−02 | 3.8497E−02 | −1.9067E−02 | 5.6542E−03 | −1.1434E−03 |
| R14 | −9.7795E−01 | 9.6801E−02 | 6.5638E−03 | 1.1442E−02 | 6.9962E−03 | 2.1786E−03 | −4.3204E−04 |

TABLE 12

| | Aspheric Coefficient | | | | | | | |
|---|---|---|---|---|---|---|---|---|
| | A16 | A18 | A20 | A22 | A24 | A26 | A28 | A30 |
| R1 | 2.0860E−02 | −4.9268E−03 | 4.8294E−04 | 0 | 0 | 0 | 0 | 0 |
| R2 | 1.0161E−02 | −2.2307E−03 | 2.0446E−04 | 0 | 0 | 0 | 0 | 0 |
| R3 | −6.6527E−04 | 6.7939E−04 | −1.3165E−04 | 0 | 0 | 0 | 0 | 0 |
| R4 | 3.2884E−02 | −6.4402E−03 | 2.5486E−04 | 0 | 0 | 0 | 0 | 0 |
| R5 | −1.9316E−01 | 6.9577E−02 | −1.0702E−02 | 0 | 0 | 0 | 0 | 0 |
| R6 | 7.3620E−02 | −2.2485E−02 | 2.6361E−03 | 0 | 0 | 0 | 0 | 0 |
| R7 | −8.7842E−01 | 2.8719E−01 | 4.0144E−02 | 0 | 0 | 0 | 0 | 0 |
| R8 | −6.2811E−02 | 1.3440E−02 | −1.1990E−03 | 0 | 0 | 0 | 0 | 0 |
| R9 | −9.7090E−02 | 3.0279E−02 | −5.3678E−03 | 4.1336E−04 | 0 | 0 | 0 | 0 |
| R10 | 1.7333E−03 | −1.8663E−04 | 8.8593E−06 | −3.0451E−08 | 0 | 0 | 0 | 0 |
| R11 | −4.7185E−03 | 1.3703E−03 | −2.5023E−04 | 2.9400E−05 | −2.1623E−06 | 9.0770E−08 | −1.6625E−09 | 0 |
| R12 | −1.5854E−03 | 4.3411E−04 | −7.5519E−05 | 8.4995E−06 | −6.0052E−07 | 2.4231E−08 | −4.2604E−10 | 0 |
| R13 | 1.6314E−04 | −1.6541E−05 | 1.1831E−02 | −5.8299E−08 | 1.8825E−09 | −3.5845E−11 | 3.0505E−13 | 0 |
| R14 | 5.8261E−05 | 5.4698E−06 | 3.5789E−07 | −1.6006E−08 | 4.6645E−10 | −7.9814E−12 | 6.0827E−14 | 0 |

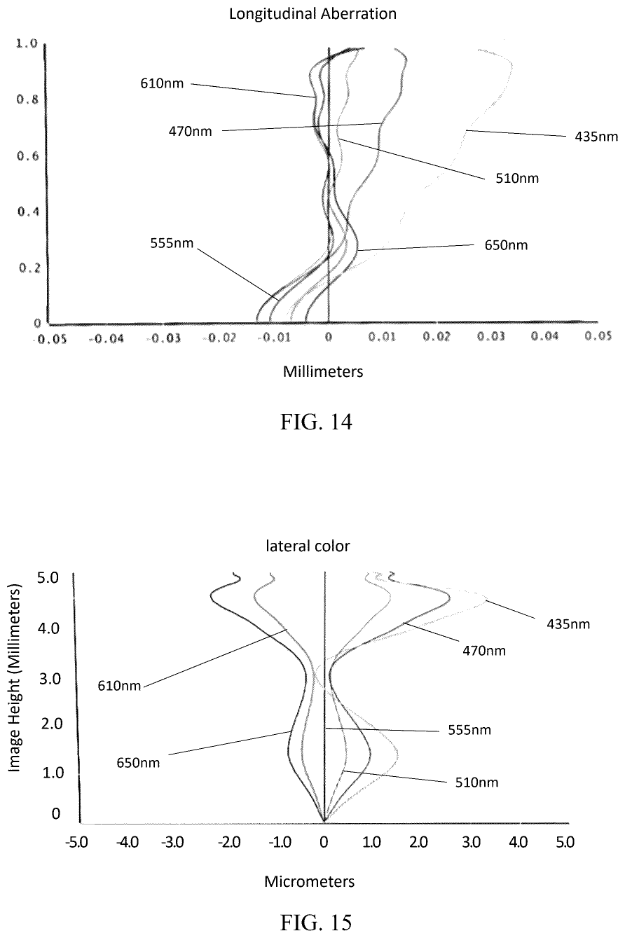

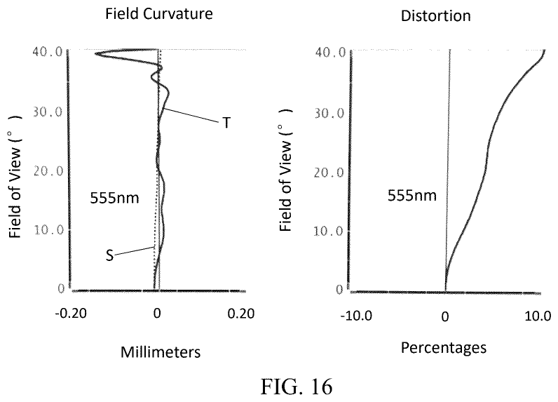

FIG. 14 and FIG. 15 respectively show longitudinal aberration and lateral color of light with wavelengths of 650 nm, 610 nm, 555 nm, 510 nm, 470 nm, and 435 nm after passing through the camera optical lens 40 according to Example 3. FIG. 16 shows field curvature and distortion of light with a wavelength of 555 nm after passing through the camera optical lens 40 according to Example 4, the field curvature S in FIG. 16 is a field curvature in the sagittal direction, and T is a field curvature in the meridian direction.

In this Example, an entrance pupil diameter ENPD of the camera optical lens is 2.876 mm, an image height IH at 1.0 field of view is 5.000 mm, a field of view FOV at 1.0 field of view is 80.90°, an image height IHm at MIC field of view is 5.200 mm, and a field of view FOVm at MIC field of view is 83.70°. The camera optical lens 40 satisfies the design requirements of large aperture, wide-angle and ultra-thinness, and the on-axis and off-axis chromatic aberration thereof are fully corrected, and has good optical performance.

Table 13 appears later to show values of various values in Example 1, Example 2, Example 3 and Example 4 corresponding to parameters specified in the relational expressions.

TABLE 13

| Parameters and | Example | Example | Example | Example |
|---|---|---|---|---|
| Relational Expressions | 1 | 2 | 3 | 4 |
| f3*d5/(R5 + R6) | 0.189 | 0.300 | 0.120 | 0.294 |
| (R11 + R12)/f6 | 3.203 | 2.200 | 4.000 | 2.200 |
| (d3 + d5)/d4 | 6.294 | 4.006 | 8.494 | 4.875 |
| f | 5.238 | 5.392 | 5.250 | 5.321 |
| f1 | 5.904 | 5.657 | 5.771 | 5.363 |
| f2 | −26.702 | −23.227 | −21.136 | −12.99 |
| f3 | 13.614 | 14.210 | 12.188 | 11.011 |
| f4 | −18.958 | −21.869 | −29.652 | −12.591 |
| f5 | −35.563 | −48.830 | −40.152 | −23.235 |
| f6 | 7.136 | 7.296 | 7.987 | 7.343 |
| f7 | −5.423 | −4.540 | −4.752 | −8.676 |
| FNO | 1.850 | 1.850 | 1.850 | 1.850 |
| TTL | 5.990 | 6.227 | 6.201 | 6.375 |
| IH | 5.000 | 5.000 | 5.000 | 5.000 |
| FOV | 85.52 | 78.53 | 79.38 | 80.90 |

The above description just refers to embodiments of the present disclosure. It should be noted that those skilled in the art can also make improvements without departing from the concept of the present disclosure, all of which shall fall within the protection scope of the present disclosure.

What is claimed is:

1. A camera optical lens, comprising seven lenses sequentially from an object side to an image side: a first lens with positive refractive power, a second lens with negative refractive power, a third lens with positive refractive power, a fourth lens with negative refractive power, a fifth lens with negative refractive power, a sixth lens with positive refractive power, and a seventh lens with negative refractive power;
wherein a focal length of the third lens is f3, a focal length of the sixth lens is f6, an on-axis thickness of the second lens is d3, an on-axis distance from an image-side surface of the second lens to an object-side surface of the third lens is d4, an on-axis thickness of the third lens is d5, a central curvature radius of the object-side surface of the third lens is R5, and a central curvature radius of an image-side surface of the third lens is R6, a central curvature radius of an object-side surface of the sixth lens is R11, a central curvature radius of an image-side surface of the sixth lens is R12, and following relational expressions are satisfied:
$$0.12 \leq f 3 * d 5 / ( R 5 + R 6 ) \leq 0.3 ;$$
$$2.2 \leq ( R 11 + R 12 ) / f 6 \leq 4. ; and$$
$$4. \leq ( d 3 + d 5 ) / d 4 \leq 8.50 .$$

2. The camera optical lens as described in claim 1, wherein a central curvature radius of an object-side surface of the seventh lens is R13, a central curvature radius of an image-side surface of the seventh lens is R14, and a following relational expression is satisfied:
$$2. \leq R 13 / R 14 \leq 3.5 .$$

3. The camera optical lens as described in claim 1, wherein, an abbe number of the first lens is v1, an abbe number of the second lens is v2, and a following relational expression is satisfied:
$$36. \leq v 1 - v 2 \leq 64.00 .$$

4. The camera optical lens as described in claim 1, wherein, a focal length of the camera optical lens is f, a focal length of the fourth lens is f4, a focal length of the fifth lens is f5, and a following relational expression is satisfied:
$$2 \leq ( f 4 - f 5 ) / f \leq 5. .$$

5. The camera optical lens as described in claim 1, wherein an object-side surface of the first lens is convex in a paraxial region, and an image-side surface of the first lens is concave in the paraxial region;
a focal length of the camera optical lens is f, a focal length of the first lens is f1, a central curvature radius of the object-side surface of the first lens is R1, a central curvature radius of the image-side surface of the first lens is R2, an on-axis thickness of the first lens is d1, and a total optical length from the object-side surface of the first lens to an image plane of the camera optical lens along an optic axis of the camera optical lens is TTL, and following relational expressions are satisfied:
$$1. 00 \leq f 1 / f \leq 1.13 ;$$
$$- 2.5 \; 1 \leq ( R 1 + R 2 ) / ( R 1 - R 2 ) \leq - 2 \text{.01} ; and$$
$$0.12 \leq d 1 / TTL \leq 0.14 .$$

6. The camera optical lens as described in claim 1, wherein an object-side surface of the second lens is convex in the paraxial region, and an image-side surface of the second lens is concave in the paraxial region;
a focal length of the camera optical lens is f, a focal length of the second lens is f2, a central curvature radius of the object-side surface of the second lens is R3, a central curvature radius of the image-side surface of the second lens is R4, a total optical length from an object-side surface of the first lens to an image plane of the camera optical lens along an optic axis of the camera optical lens is TTL, and following relational expressions are satisfied:
$$- 5.10 \leq f 2 / f \leq - 2.44 ;$$
$$4.82 \leq ( R 3 + R 4 ) / ( R 3 - R 4 ) \leq 7.65 ; and$$
$$0.03 \leq d 3 / TTL \leq 0.04 .$$

7. The camera optical lens as described in claim 1, wherein the object-side surface of the third lens is convex in a paraxial region, and the image-side surface of the third lens is concave in the paraxial region;
a focal length of the camera optical lens is f, a total optical length from an object-side surface of the first lens to an image plane of the camera optical lens along an optic axis of the camera optical lens is TTL, and following relational expressions are satisfied:
$$2.06 \leq f 3 / f \leq 2.64 ;$$
$$- 1.99 \leq ( R 5 + R 6 ) / ( R 5 - R 6 ) \leq - 1.34 ; and$$
$$0.05 \leq d 5 / TTL \leq 0.08 .$$

8. The camera optical lens as described in claim 1, wherein an object-side surface of the fourth lens is concave in the paraxial region;
a focal length of the camera optical lens is f, a focal length of the fourth lens is f4, a central curvature radius of the object-side surface of the fourth lens is R7, a central curvature radius of an image-side surface of the fourth lens is R8, an on-axis thickness of the fourth lens is d7, a total optical length from an object-side surface of the first lens to an image plane of the camera optical lens along an optic axis of the camera optical lens is TTL, and following relational expressions are satisfied:
$$- 5.65 \leq f 4 / f \leq - 2 \text{.36} ;$$
$$- 2.9 \; 4 \leq ( R 7 + R 8 ) / ( R 7 - R 8 ) \leq - 0.22 ; and$$
$$0.04 \leq d 7 / TTL \leq 0.07 .$$

9. The camera optical lens as described in claim 1, wherein an object-side surface of the fifth lens is concave in the paraxial region, and an image-side surface of the fifth lens is concave in the paraxial region;
a focal length of the camera optical lens is f, a focal length of the fifth lens is f5, a central curvature radius of the object-side surface of the fifth lens is R9, a central curvature radius of the image-side surface of the fifth lens is R10, an on-axis thickness of the fifth lens is d9, a total optical length from an object-side surface of the first lens to an image plane of the camera optical lens along an optic axis of the camera optical lens is TTL, and following relational expressions are satisfied:
$$- 9.06 \leq f 5 / f \leq - 4 \text{.36} ;$$
$$- 1.72 \leq ( R 9 + R 10 ) / ( R 9 - R 10 ) \leq 0.96 ; and$$
$$0.05 \leq d 9 / TTL \leq 0.08 .$$

10. The camera optical lens as described in claim 1, wherein an object-side surface of the sixth lens is convex in a paraxial region, and an image-side surface of the sixth lens is concave in the paraxial region;
a focal length of the camera optical lens is f, a focal length of the sixth lens is f6, an on-axis thickness of the fifth lens is d11, a total optical length from an object-side surface of the first lens to an image plane of the camera optical lens along an optic axis of the camera optical lens is TTL, and following relational expressions are satisfied:
$$1. 35 \leq f 6 / f \leq 1.53 ;$$
$$- 1.66 \leq ( R 11 + R 12 ) / ( R 11 - R 12 ) \leq - 1.33 ; and$$
$$0.07 \leq d 11 / TTL \leq 0.11 .$$

11. The camera optical lens as described in claim 1, wherein an object-side surface of the sixth lens is convex in the paraxial region, and an image-side surface of the sixth lens is concave in the paraxial region;
a focal length of the camera optical lens is f, a focal length of the seventh lens is f7, a central curvature radius of an object-side surface of the seventh lens is R13, a central curvature radius of an image-side surface of the seventh lens is R14, an on-axis thickness of the seventh lens is d13, a total optical length from an object-side surface of the first lens to an image plane of the camera optical lens along an optic axis of the camera optical lens is TTL, and following relational expressions are satisfied:
$$- 1.64 \leq f 7 / f \leq - 0 \text{.84} ;$$
$$1. 80 \leq ( R 13 + R 14 ) / ( R 13 - R 14 ) \leq 3. ; and$$
$$0.05 \leq d 13 / TTL \leq 0.13 .$$

12. The camera optical lens as described in claim 1, wherein the first lens is made of glass.
